(19) United States
(12) Patent Application Publication
(10) Pub. No.: US 2006/0115218 A1
(43) Pub. Date: Jun. 1, 2006

(54) Boot for an optical ferrule

(75) Inventors: Joseph P. Howard, Hickory, NC (US); Darrell R. Childers, Hickory, NC (US)

Correspondence Address: Michael L. Leetzow, Esq.;Michael L. Leetzow, P.A., 5213 SHORELINE CIRCLE, SANFORD, FL, 32771, US

(73) Assignee: US Conec, Ltd.

(21) Appl. No.: 10/999,399

(22) Filed: Nov. 29, 2004

(51) Int. Cl. G02B 6/38; G02B 6/36

(52) U.S. Cl. 385/59; 385/55; 385/56; 385/58; 385/76; 385/77

(57) ABSTRACT

A boot for a ferrule is provided that has a body member having a first end and a second end with an opening therethrough. The opening also has a web member extending from the first end to the second end to define at least two channels. The boot may also have indicia on the outside surface to indicate a direction of insertion of the boot into the ferrule. The boot may also have a limiting member to prevent the boot from being inserted too far into the ferrule.

The present invention relates to a boot for an optical ferrule, and more particularly, a boot for an optical ferrule that has two channels through the boot, indicia to assist in inserting the boot into a ferrule, and a limiting member to prevent the boot from being inserted too far.

There are prior art devices including, for example, boots that have webs that extend along only a portion of the boot to separate the multiple optical fiber ribbons in a ferrule, allowing epoxy to wick up the optical fiber ribbons. The wicking of the epoxy causes problems with the optical fibers when the ferrules are installed. The optical fibers, because of the misplaced epoxy, suffer damage and breakage.

Accordingly, the present invention is directed to a boot for an optical ferrule that substantially obviates one or more of the problems and disadvantages in the prior art. Additional features and advantages of the invention will be set forth in the description that follows, and in part will be apparent from the description, or may be learned by practice of the invention. The objectives and other advantages of the invention will be realized and attained by the apparatus and process particularly pointed out in the written description and claims, as well as the appended drawings.

### SUMMARY OF THE INVENTION

To achieve these and other advantages and in accordance with the purpose of the invention as embodied and broadly described herein, the invention is directed to a ferrule boot for protecting at least two optical fiber ribbons connected to a terminal connector, each optical fiber ribbon having at least two fibers including a body member having a first end and second end, and a web member disposed in the opening of the body member and extending from the first to the second end to define at least two channels extending lengthwise through the body member between the first end and the second end.

In another aspect, the invention provides for a ferrule boot for protecting at least two optical fiber ribbons connected to a terminal connector, each optical fiber ribbon having at least two fibers, including a body member having a first end and second end, a web member disposed in the opening of the body member and extending from the first end to the second end to define at least two channels extending lengthwise through the body member between the first end and the second end, and indicia on an outside surface of the ferrule boot to indicate a direction of insertion of the ferrule boot into a ferrule.

In yet another aspect, the invention is directed to a ferrule boot for protecting at least two optical fiber ribbons connected to a terminal connector including a body member defining at least two channels, each of the at least two channels extending lengthwise through the body member, and at least one insert limiting member on a surface of the body member to limit depth of insertion of the ferrule boot into a ferrule.

In yet another aspect, the invention is directed to a ferrule boot for protecting at least two optical fiber ribbons connected to a terminal connector including a body member having a first end and a second end, the body member also having a front portion and a rear portion, the front portion having curved corners with a first radius and the rear portion having curved corners with a second radius, and a web member disposed in the opening of the body member and extending from the first end to the second end to define at least two channels extending lengthwise in the body member between the first end and the second end.

It is to be understood that the foregoing general description and the following detailed description are exemplary and explanatory and are intended to provide further explanation of the invention as claimed.

The accompanying drawings are included to provide a further understanding of the invention and are incorporated in and constitute a part of the specification. The drawings illustrate several embodiments of the invention and together with the description serve to explain the principles of the invention.

### BRIEF DESCRIPTION OF THE DRAWINGS

FIG. 1 is a perspective view of one embodiment of a boot for a ferrule according to the present invention;

FIG. 2 is a side elevational view of the boot of FIG. 1;

FIG. 3 is an end view of the boot of FIG. 1; and

FIG. 4 is a cross sectional view of the boot of FIG. 3 along the line 4-4; and

FIG. 5 is a perspective view of the boot of FIG. 1 prior to being inserted into an optical ferrule;

FIG. 6 is a perspective view of the boot inserted into the ferrule illustrated in FIG. 5; and

FIG. 7 is a cross sectional view of the boot and optical ferrule of FIG. 6 along line 7-7.

### DETAILED DESCRIPTION OF THE INVENTION

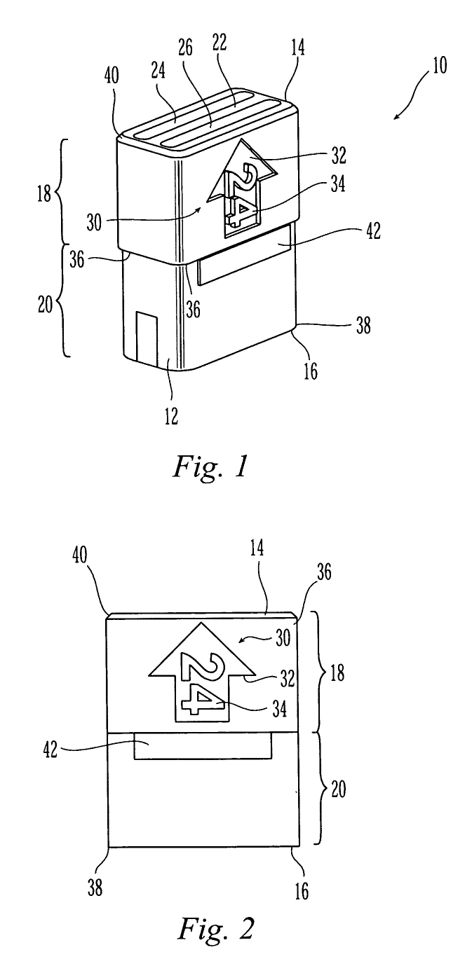

A boot 10 for use with an optical ferrule is illustrated in FIG. 1. The boot 10 has a body member 12 that has a first end 14 and a second end 16. The body member 12 also has a front portion 18 and a rear portion 20, generally corresponding to the first end 14 and second end 16, respectively. The boot 10 also has a web member 22 that extends the length of the body member 12 from the first end 12 to the second end 14, defining two channels 24,26 along the length of the body member 12. The channels 24,26 are appropriately sized to preferably receive one optical fiber ribbon (not shown). The web member 22 is preferably integral with the body member 12, but may be added later or in a subsequent step. While the web member is preferably made from the same material as the body member 12, it may be made of a different material as well.

The boot 10 preferably has indicia 30 on the outside surface to indicate in which direction the boot 10 is to be inserted into the ferrule and it may also indicate the size of the boot 10, the number of optical fibers it can manage, or even the type of ferrule it could be used with. In the embodiment illustrated in the figures, the indicia 30 includes an arrow 32 indicating the direction that boot 10 should be inserted into the ferrule. The indicia 30 may also include the size of the boot with, for example, the numeral 34, which indicates that the boot 10 will accommodate twenty-four fibers. Other indicia 30 may also be used, including letters, other signs or symbols, and designs.

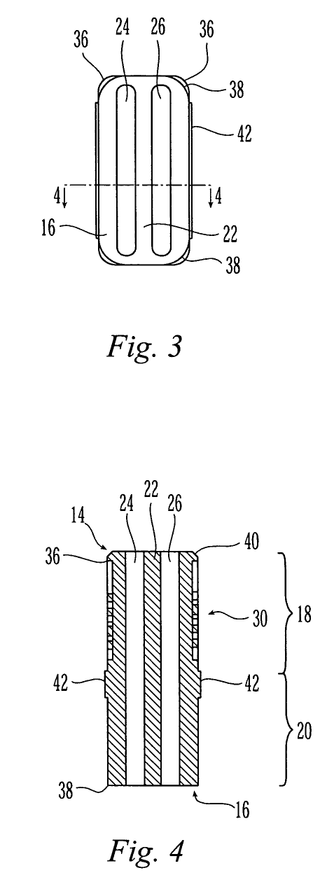

As can be seen in FIG. 1 and better in FIG. 3, the corners of boot 10 have two different radii at the front portion 18 and the rear portion 20. The radius of the corners 36 at the front portion 18 is smaller than the radius of the corners 38 at the rear portion 20. The radius of corners 36 at the front portion 18 is preferably about 0.30 mm and the radius of corners 38 at the rear portion 20 is preferably about 0.50 mm. It should be noted that the radii of the corners 36,38 may have other values and they may all have the same value as well. However, the smaller radius of the corners 36 allows for a tighter fit of the boot 10 in the ferrule and prevents the epoxy from leaking out around the outside of the boot 10.

The first end 14 of boot 10 preferably has a chamfer 40 around the circumference to assist in inserting the boot 10 into the ferrule.

Insert limiting members 42 are illustrated on two outside surfaces of the body member 12. While the insert limiting members 42 are shown on the wider side of the boot 10, they could be on any of the four sides of boot 10. The insert limiting member 42 is preferably integrally formed with the boot 10 and is preferably about 0.05 mm in height. The insert limiting member 42 provides a physical stop as well as a visual stop so that the boot 10 is not inserted too far into the ferrule. While the insert limiting member 42 is illustrated as being rectangular in shape, it could be of any appropriate shape or size, i.e, it could be a larger or smaller rectangle, a square, have a ramp-like configuration, or even be a simple line with little or no height.

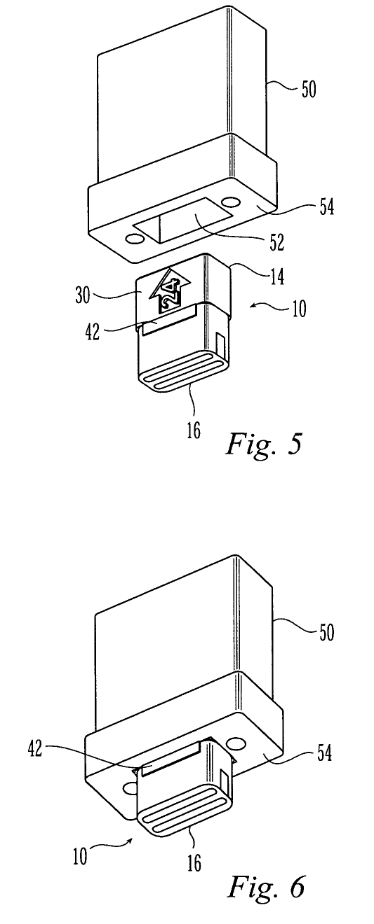

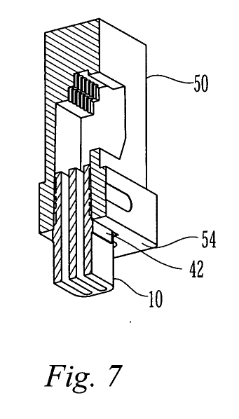

The boot 10 is illustrated in FIG. 5 in a position to be inserted into a ferrule 50. The ferrule 50 is illustrated as being an MT ferrule, but could be of any appropriate configuration. The ferrule 50 has a rectangular opening 52 in the ferrule's rear surface 54. The boot 10 is oriented in alignment with indicia 30, which indicates the direction the boot 10 is to be inserted. Once the boot 10 is inserted in the direction indicated by the indicia 30, the boot 10 is pushed in until the insert limiting member 42 contacts or is aligned with the rear surface 54 of the ferrule 50.

The smaller radius of the corners 36 at the front portion 18 of boot 10 provides a closer fit of the boot 10 in the corners of the opening 52 of the ferrule 50. The closer fit of the corners 36 prevents epoxy used to secure the optical fiber ribbons in the ferrule 50 from wicking out of the ferrule 50 and around the boot 10. The web member 22 in boot 20 prevents the epoxy from wicking along the optical fiber ribbons and coming out of the channels 24,26.

The boot 10 is preferably made from an elastomeric material such as a thermoplastic elastomer. However, any appropriate material may be used. Such materials include thermoset elastomer, silicone, or a thermoplastic polymer.

It will be apparent to those skilled in the art that various modifications and variations can be made in the boot of the present invention without departing from the spirit or scope of the invention. Thus, it is intended that the present invention cover the modifications and variations of this invention provided they come within the scope of the appended claims and their equivalents.

We claim:

1. A ferrule boot for protecting at least two optical fiber ribbons connected to a terminal connector, each optical fiber ribbon having at least two fibers, comprising:
a body member having a first end and second end; and
a web member disposed in the opening of the body member and extending from the first to the second end to define at least two channels extending lengthwise through the body member between the first end and the second end.

2. The ferrule boot according to claim 1, further comprising indicia on an outside surface of the ferrule boot to indicate a direction of insertion of the ferrule boot into a ferrule.

3. The ferrule boot according to claim 2, wherein the indicia on the outside surface of the ferrule boot is selected from the group of indicia including numbers, designs, arrows, letters, and symbols.

4. The ferrule boot according to claim 1, wherein the web member is integral with the body member.

5. The ferrule boot according to claim 1, wherein the body member and the web member are comprised of an elastomeric material.

6. A ferrule boot for protecting at least two optical fiber ribbons connected to a terminal connector, each optical fiber ribbon having at least two fibers, comprising:
a body member having a first end and second end;
a web member disposed in the opening of the body member and extending from the first end to the second end to define at least two channels extending lengthwise through the body member between the first end and the second end; and
indicia on an outside surface of the ferrule boot to indicate a direction of insertion of the ferrule boot into a ferrule.

7. A ferrule boot for protecting at least two optical fiber ribbons connected to a terminal connector comprising:
a body member defining at least two channels, each of the at least two channels extending lengthwise through the body member; and
at least one insert limiting member on a surface of the body member to limit depth of insertion of the ferrule boot into a ferrule.

8. The ferrule boot according to claim 7, wherein the at least one insert limiting member comprises two insert limiting members

9. The ferrule boot according to claim 8, wherein the two insert limiting members are on opposite sides of the body member.

10. The ferrule boot according to claim 7, further comprising indicia on an outside surface of the ferrule boot to indicate a direction of insertion of the boot into a ferrule.

11. A ferrule boot for protecting at least two optical fiber ribbons connected to a terminal connector comprising:
a body member having a first end and a second end, the body member also having a front portion and a rear portion, the front portion having curved corners with a first radius and the rear portion having curved corners with a second radius; and
a web member disposed in the opening of the body member and extending from the first to the second end to define at least two channels extending lengthwise in the body member between the first end and the second end.

12. The ferrule boot according to claim 11, wherein the first and second radius are the same.

13. The ferrule boot according to claim 11, wherein the first radius is larger than the second radius.

14. The ferrule boot according to claim 11, further comprising an inserting limiting member on at least one surface to limit depth of insertion of the ferrule boot into a ferrule.

15. The ferrule boot according to claim 11, further comprising indicia on an outside surface of the ferrule boot to indicate a direction of insertion of the boot into a ferrule.

16. The ferrule boot according to claim 14, further comprising indicia on an outside surface of the ferrule boot to indicate a direction of insertion of the boot into a ferrule.

17. A ferrule boot for protecting at least one optical fiber ribbon connected to a terminal connector comprising:
a body member defining at least one channel, the at least one channel extending lengthwise through the body member; and
at least one insert limiting member on a surface of the body member to limit depth of insertion of the ferrule boot into a ferrule.

18. A ferrule boot for protecting at least one optical fiber ribbon connected to a terminal connector comprising:
a body member defining at least one channel, the at least one channel extending lengthwise through the body member; and
indicia on an outside surface of the ferrule boot to indicate a direction of insertion of the boot into a ferrule.
